(19) United States
(12) Patent Application Publication
(10) Pub. No.: US 2002/0131233 A1
(43) Pub. Date: Sep. 19, 2002

(54) Receptacle structure for computer hard-disk

(76) Inventor: Ying-Hsi Hsu, San-Chung City (TW)

Correspondence Address: Ying-Hsi Hsu, P.O. Box No. 6-57, Chung-Ho City, Taipei Hsien, 235, TW

(21) Appl. No.: 09/810,407

(22) Filed: Mar. 19, 2001

(51) Int. Cl. G06F 1/16

(52) U.S. Cl. 361/685

(57) ABSTRACT

An improved receptacle structure for computer hard-disk comprises of a tongue piece and a receptacle slot, wherein the tongue piece is mounted at the rear end of the hard-disk and connected to the circuit board of the hard-disk, with a horizontal flange on one side to be inserted with the receptacle slot and terminal pieces disposed in equal intervals on the upper and the lower sides of the horizontal flange; a plurality of terminal pieces are mounted on the upper and the lower sides of the receptacle slot to contact correspondingly with the upper and the lower terminal pieces on the horizontal flange of the tongue piece mentioned above; the footing terminals extended perpendicularly downwards from the rear end, available for the upper and the lower terminal pieces, of the receptacle slot connect parallelly and correspondingly to the mother board; the assembly of the said tongue piece and the receptacle slot makes the installation of the computer hard-disk more convenient, reduces the cost of the materials required and increases the economic effect.

### BACKGROUND OF THE INVENTION

1) Field of the Invention

The invention herein relates to an improved receptacle structure for computer hard-disk mainly corrects the shortcomings of the installation of the conventional hard-disk and enhances the convenience of it to reduce the cost of materials required and increase the economic effect.

2) Description of the Prior Art

The conventional receptacle structure for computer hard-disk, as shown in FIG. 1, is mainly mounted with a plurality of upper and the lower footing terminals (11) at the rear end of the hard-disk (1), then the upper and the lower gang holes (not shown in the Fig.) on one side of the female receptacle (2) are inserted to the upper and the lower footing terminals (11) at the rear end of the hard-disk (1), to make the footing terminals (11) contact the terminal pieces (211) inside the inserting slot (21) disposed on the other side of the female receptacle (2); the inserting slot (21) is to be inserted by the horizontal flange (31) on one side of a male receptacle (3); the upper and the lower terminal pieces (311) on the horizontal flange (31) contact the terminal pieces (211) inside the inserting slot (21); the footing terminals (32) extended perpendicularly downwards on the other side of the male receptacle (3) are inserted onto the mother board (not shown in the FIG.).

From the foregoing sections, when installing the hard-disk (1) into the computer, by inserting the inserting slot (21) on one side of the female receptacle (2) at the rear end of the hard-disk (1) toward the horizontal flange (31) on one side of the male receptacle (3), the hard-disk (1) can be located into the computer for conducting the reading and the saving of the information on the hard-disk (1). However, it takes more members to assemble the receptacle structure of the hard-disk. That causes the increase of the cost of the materials required and reduces the economic effect. Therefore, some manufacturers combine the mentioned female receptacle (2) and the male receptacle (3) to one receptacle (7), as shown in FIG. 2. The upper and the lower gang holes (not shown in the FIG.) are mounted on one side of the receptacle (7) to be inserted correspondingly by the upper and the lower footing terminals (11) at the rear end of the hard-disk (1); the other side is mounted with the footing terminals (71) extended perpendicularly downwards to be inserted onto the mother board (not shown in the FIG.). When installing the hard-disk (1) into the computer, by inserting the upper and the lower footing terminals (11) at the rear end of the hard-disk (1) correspondingly to the upper and the lower gang holes (not shown in the FIG.) of the receptacle (7), the hard-disk can be located into the computer for conducting the reading and the saving of the information on the hard-disk (1).

From the foregoing sections, although the conventional receptacle structure of the hard-disk has been improved, as the upper and the lower footing terminals (11) at the rear end of the hard-disk (1) are inserted into the gang holes on the receptacle (7), the footing terminals (11) are easily distorted further destroy the hard-disk due to the difficulty of aligning the footing terminals (11) with the gang holes on the receptacle (7). Therefore, in view of the shortcomings and inconvenience mentioned above, the inventor of the invention herein based on the spirit of researching, innovating and pursuing for the best, through the professional prospect and knowledge, has developed an improved receptacle structure for computer hard-disk with more practical value and wider applicative scope to meet industrial usable value.

### SUMMARY OF THE INVENTION

The invention herein has the conventional receptacle structure for hard-disk directly substituted by comprising of a tongue piece and a receptacle slot, wherein the tongue piece is mounted at the rear end of the hard-disk and connected to the circuit board of the hard-disk, with a horizontal flange on one side to be inserted with the receptacle slot and terminal pieces disposed in equal intervals on the upper and the lower sides of the horizontal flange; a plurality of terminal pieces are mounted on the upper and the lower sides of the receptacle slot to contact correspondingly with the terminal pieces on the upper and the lower sides of the horizontal flange on the tongue piece mentioned above; the footing terminals extended perpendicularly downwards from the rear end, available for the upper and the lower terminal pieces, of the receptacle slot connect parallelly and correspondingly to the mother board.

The primary objective of the invention herein, through the designed structure of the tongue piece and the receptacle slot mentioned above, is to improve the shortcomings of the installation of the conventional hard-disk and to enhance the convenience of installing the hard-disk.

Another objective of the invention herein is to reduce the cost of materials required so as to increase the economic effect.

To enable a further understanding of the efficiency, the structure and the features of the invention herein, the brief description of the drawings below is followed by the detailed description of the preferred embodiment.

### BRIEF DESCRIPTION OF THE DRAWINGS

FIG. 1 is an exploded and pictorial drawing of a conventional receptacle structure for hard-disk.

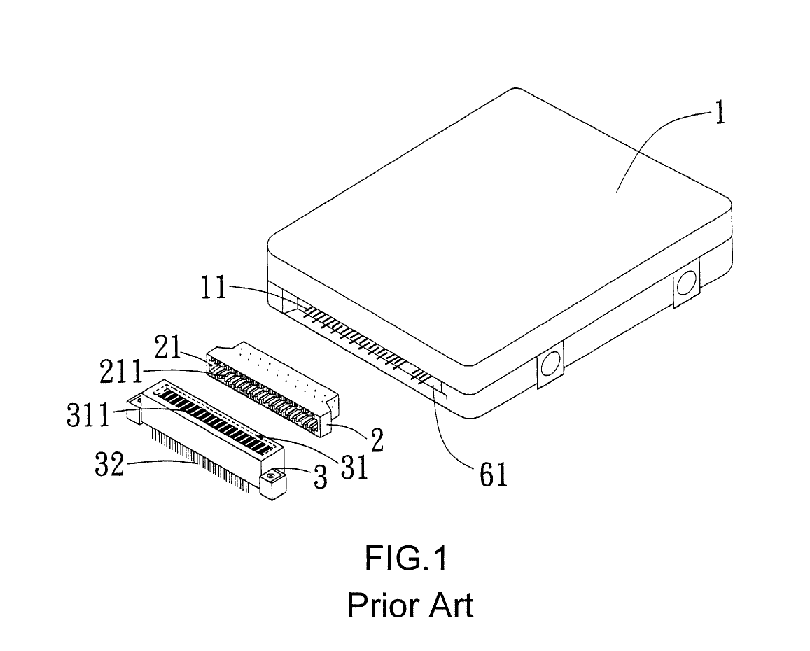

FIG. 2 is another exploded and pictorial drawing of a conventional receptacle structure for hard-disk.

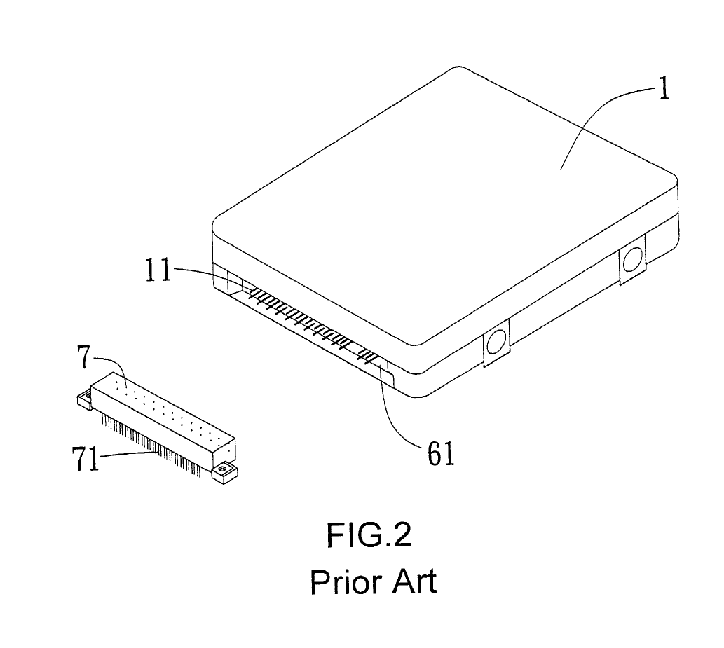

FIG. 3 is an exploded and pictorial drawing of the invention herein.

FIG. 4 is an assembled and pictorial drawing of the invention herein.

### DETAILED DESCRIPTION OF THE PREFERRED EMBODIMENT

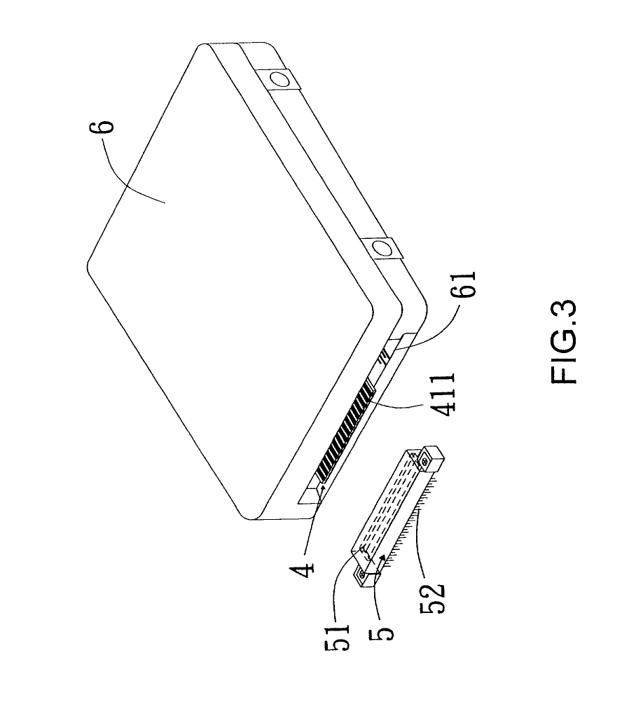

Referring to FIG. 3 of an exploded and pictorial drawing of the invention herein that mainly comprises of:

A tongue piece (4) mounted at the rear end of the hard-disk (6) and connected to the circuit board of the hard-disk (6), with a horizontal flange (41) on one side to be inserted with the receptacle slot (5) and terminal pieces (411) disposed in equal intervals on the upper and the lower sides of the horizontal flange (41);

A receptacle slot (5) with a plurality of terminal pieces (51) mounted on the upper and the lower sides to contact correspondingly with the upper and the lower terminal pieces (411) on the horizontal flange (41) of the said tongue piece (4); the footing terminals (52) extended perpendicularly downwards from the rear end, available for the upper and the lower terminal pieces (51), of the receptacle slot (5) connect parallelly and correspondingly to the mother board (not shown in the FIG.).

The assembly of the said members enables the convenience of installing the computer hard-disk and reduces the cost of materials required to increase the economic effect.

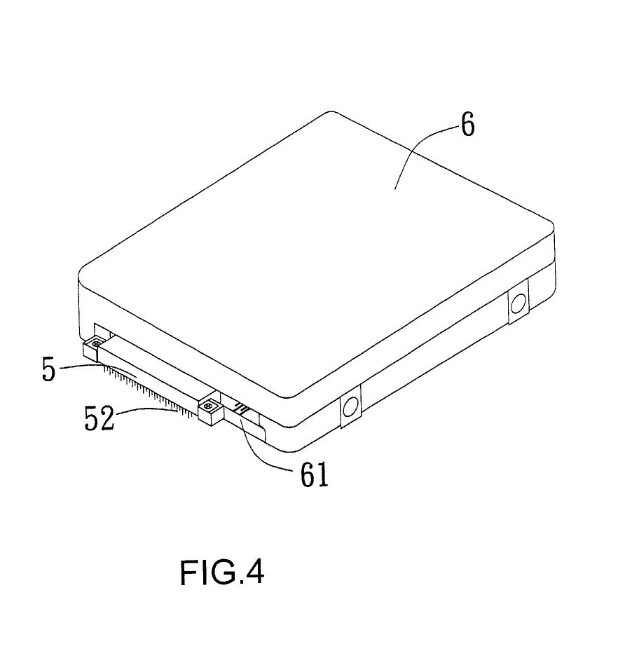

Referring to FIG. 4, when installing the hard-disk (6) into the computer, by inserting the horizontal flange (41) mounted on the tongue piece (4) at the rear end of the hard-disk (6) to the receptacle slot (5) connected on the mother board, the hard-disk (6) can be located into the computer to conduct the reading and the saving of the information on the hard-disk (6).

In summation of the foregoing sections, the improved receptacle structure for the computer hard-disk capable of substantially enhancing the convenience of the hard-disk installation and reducing the cost of materials required is obviously an invention of more practical value and economic effect than the conventional receptacle structure for the hard-disk; furthermore, the said structure and efficient features are innovative and able to increase the efficiency; therefore the invention herein fully complies with all new patent application requirements and is hereby submitted to the patent bureau for review and the granting of the commensurate patent rights.

The description and drawings revealed above are for one of the examples of the invention herein, but not for restricting the preferred embodiment scope of the invention herein; therefore, any modified or substitute variation deviated from the description mentioned above and the following claims should be included within the protected patent scope of the invention herein.

1. An improved receptacle structure for computer hard-disk comprises of:
A tongue piece mounted at the rear end of the hard-disk and connected to the circuit board of the hard-disk, with a horizontal flange on one side to be inserted with the receptacle slot and terminal pieces disposed in equal intervals on the upper and the lower sides of the horizontal flange;
A receptacle slot with a plurality of terminal pieces mounted on the upper and the lower sides to contact correspondingly with the terminal pieces on the upper and the lower sides of the horizontal flange on the said tongue piece; the footing terminals extended perpendicularly downwards from the rear end, available for the upper and the lower terminal pieces, of the receptacle slot connect parallelly and correspondingly to the mother board;
The assembly of the said members makes the installation of the computer hard-disk more convenient, reduces the cost of the materials required and increases the economic effect.
